(19) United States
(12) Patent Application Publication
(10) Pub. No.: US 2012/0080100 A1
(43) Pub. Date: Apr. 5, 2012

(54) Aerosol gas and or liquid valve stem

(76) Inventor: Roderic Nathan Uphaus, Troy, AL (US)

(21) Appl. No.: 13/200,575

(22) Filed: Sep. 26, 2011

Related U.S. Application Data
(60) Provisional application No. 61/404,188, filed on Sep. 30, 2010.
(60) Provisional application No. 61/575,310, filed on Aug. 19, 2011.

(51) Int. Cl. F16K 43/00

(52) U.S. Cl. 137/321

(57) ABSTRACT

A new and improved valve stem for use in aerosol can taps or valves. This type of aerosol can tap being of design to thread onto an aerosol can cap for the purpose of opening an releasing the can content and closing the can content at will. This type of can tap would be found in use recharging an automotive air conditioning systems. The valve stem being centrally located within the valve tap assembly with one end extending from the valve body supporting a tee handle for rotating the stem within a threaded portion of the valve body and the opposite end supporting the means to depress the can cap valve.

### BACKGROUND OF THE INVENTION

Disclosed is an improved valve for the distribution of R134a Freon commonly used in automobiles today. The R134a Freon is not new to the market, infact the product has been in use for well over 17 years.

The R134a is commonly marketed in auto parts stores and available in steel cans much like the common aerosol cans. The primary difference between the R134a cans of today and an aerosol can is the R134a can have a metal cap which requires puncturing to release the freon. Special tools or R-134a can tap and dispensing valves are need to properly puncture and dispense the Freon from the can. A common valve of this type is marketed by AUTO ZONE of Memphis, Tenn. under the Quest name and 421 part number.

This type of valve has threads on an inner portion of the valve body that thread onto the metal cap of the can which have a male matching threads. Once the valve is tightly threaded onto the can, a sharp puncturing pen is screwed into and thru the metal can top allowing the gas and liquid to be released as the pen is unscrewed.

Inherent issues exist with this type of puncturing valve system. After the can is punctured there is no way of resealing the can.

This R-134a is used to recharge the air conditioning systems of automobiles. In many cases an entire can of the R-134a is not required to complete a recharge of the system. Because the can top has been punctured, it cannot be resealed for later use. Typically the remaining content of the can is released into the atmosphere causing damage to the environment.

Recently, the state of California and the Environmental Protection Agency have required companies manufacturing and distributing the R-134a Freon to package the product in resealable containers. Because of the pressures that the Freon must be stored under to keep the chemical in a liquid state, steel cans are used in the packaging of the Freon.

Resealable valves are readily available for this type of can from manufactures such as Newman-Green of Addison, Ill.
Common uses of this type of resealable valve can be found on spray paint cans marketed by Wal-Mart of Bentonville Ark. under the Dupli-Color name.
This type of resealable “can cap” as they are known in the industry, can have other features such as threads over the exterior valve portion of the cap. Threads of this style can be found on the solid puncher style caps found on R-134a Freon cans sold today.

Having a cap that reseals itself and has the exterior threads is what some of the manufacturers, packagers, and distributors of the R-134a have chosen to meet the requirements of the EPA for future sales of the Freon product. The K-12-118 Acme thread self sealing aerosol valve is an example of this type of valve made by Newman-Green.

Because there has been no need for a special type of valve of this kind (Also referred to as taps) it does not currently exist and therefore simply could not be obvious to someone of the art. Although the new valves uses many of the components of the needle puncher style valve of today, the gas or fluid release mechanisms (stems) are different and unique.

To best describe the use and function of the prior art and the current invention, attention should be given to the following description of parts and figures along with the drawings and the detailed explanation where common numbers denote the same component.

### FIGURE EXPLANATION

FIG. 1 Can and valve assembly standing in an upright position.

FIG. 2 Puncture style valve side view in upright position.

FIG. 3 Puncture can cap detail prior art

FIG. 4 Valve body side view in upright position.

FIG. 5 Piercing needle assembly detail drawing of upright side view.

FIG. 6 Cutaway of piercing needle valve in an upright side view.

FIG. 7 Can assembly with resealable valve “can cap” from an upper side view

FIG. 8 Resealable can cap.

FIG. 9 New valve assembly with passages in a prospective side view.

FIG. 10 Cutaway of new valve assembly for resealable caps in an upright prospective side view.

FIG. 11 Cutaway of resealable valve assembly and resealable can cap in a prospective side view showing gas and or liquid flow.

FIG. 12 Side view of second stem design.

FIG. 13 front side view of second stem design.

FIG. 14 Cutaway view of complete valve and Newman-Green K-12 can cap with the second stem design.

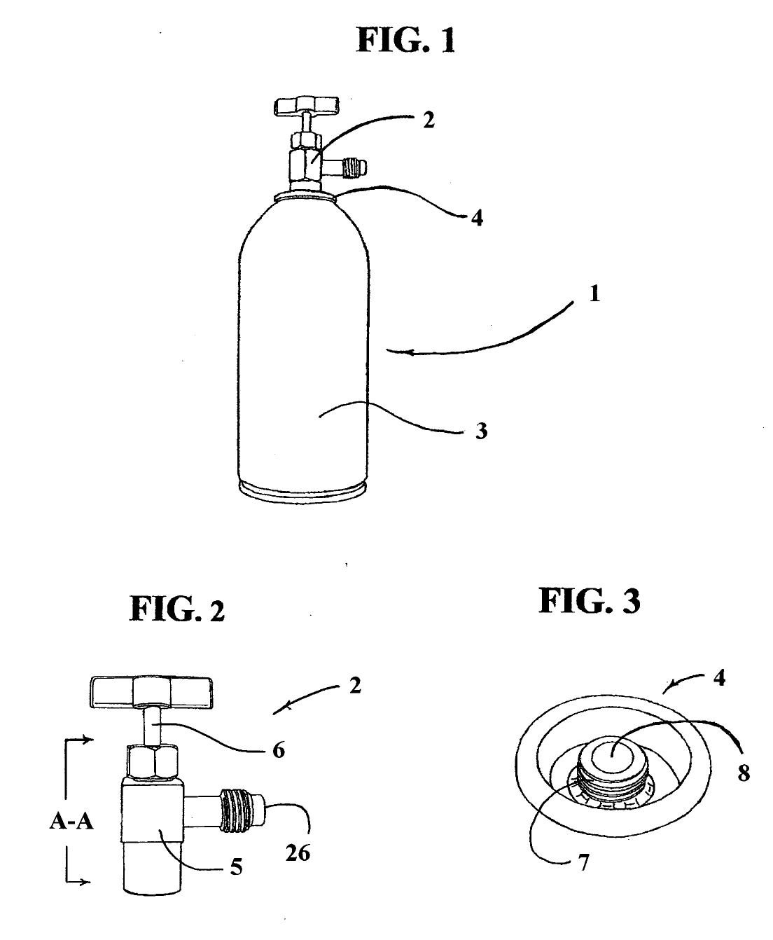

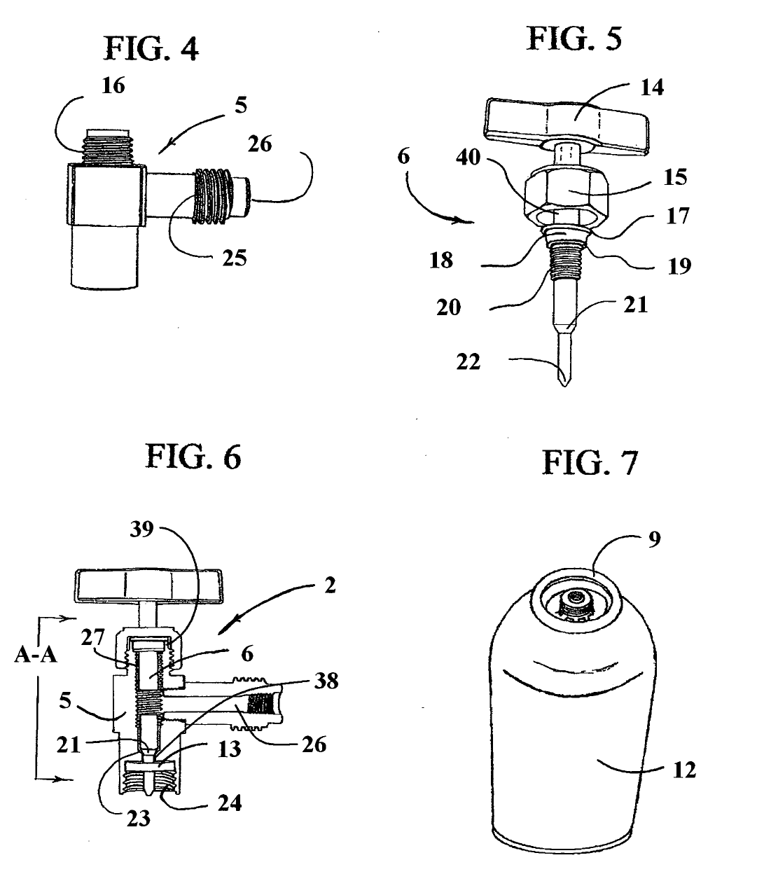

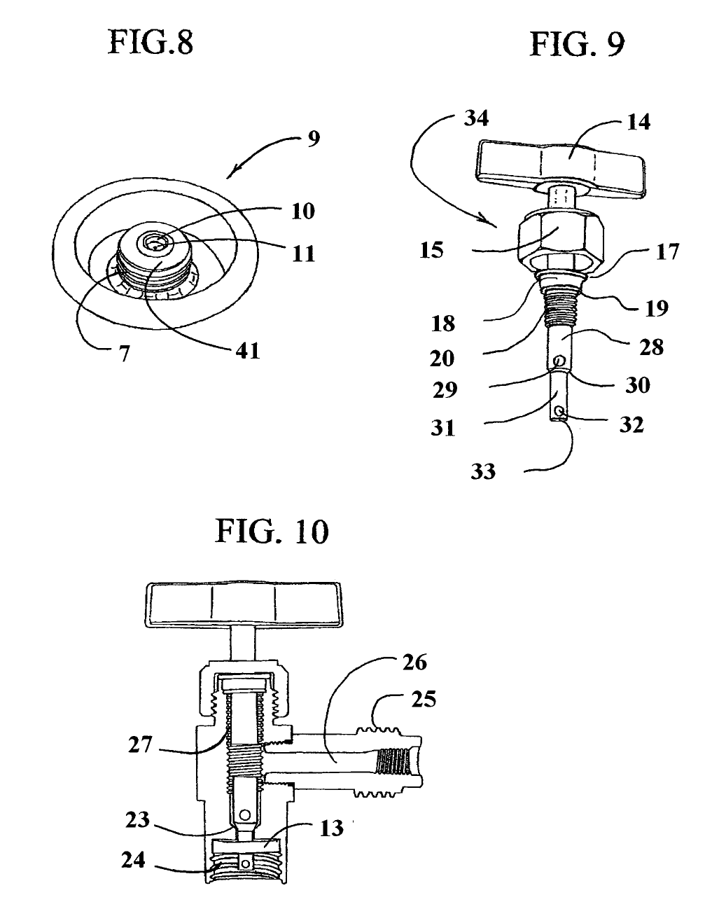

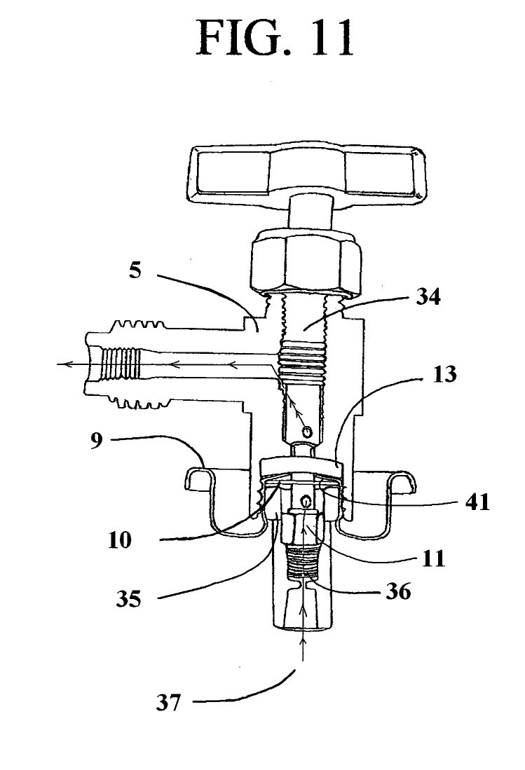

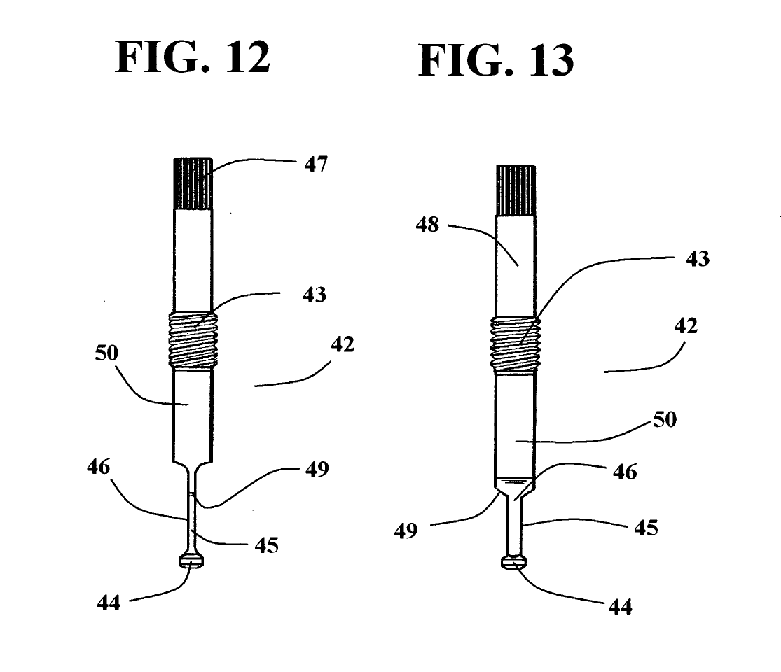

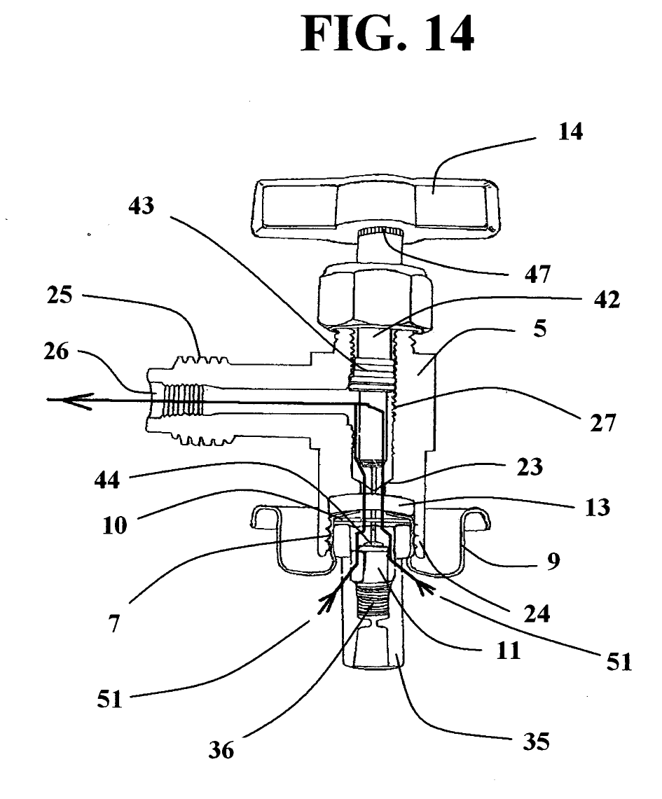

### COMPONENT NAMES

| | | |
|---|---|---|
| 1 | Can and valve assembly | FIG. 1 |
| 2 | Valve complete - Pryor art | FIG. 2 and 6 |
| 3 | Can | FIG. 1 |
| 4 | Can cap - Pryor art | FIG. 1, and 3 |
| 5 | Valve body | FIG. 2, 4, 6, and 14 |
| 6 | Piercing needle assembly | FIG. 2, 5 and 6 |
| 7 | Male ½ ACME thread on cap | FIG. 3, 8, and 14 |
| 8 | Solid cap puncture point | FIG. 3 |
| 9 | Can cap aerosol valve style | FIG. 7, 8, 11, and 14 |
| 10 | Aerosol can cap valve seal | FIG. 8, 11, and 14 |
| 11 | Can cap valve | FIG. 8, 11, and 14 |
| 12 | Chemical can | FIG. 7 |
| 13 | Seal | FIG. 6, 10, 11, and 14 |
| 14 | Tee knob | FIG. 5, 9, and 14 |
| 15 | Retaining nut | FIG. 5 and 9 |
| 16 | Retaining threads for needle assembly | FIG. 4 |
| 17 | Upper metal seal washer | FIG. 5 and 9 |
| 18 | Upper rubber seal washer | FIG. 5 and 9 |
| 19 | Lower metal seal washer | FIG. 5 and 9 |
| 20 | Needle assembly threads | FIG. 5 and 9 |
| 21 | Needle seat | FIG. 5 and 6 |
| 22 | Piercing needle | FIG. 5 |
| 23 | Valve body seat | FIG. 6, 10 and 14 |
| 24 | ½ female Acme thread in valve body | FIG. 6 and 10 |
| 25 | Male thread for extension hose | FIG. 4, 10 and 14 |
| 26 | Exiting tube | FIG. 2, 4, 6, 10, and 14 |
| 27 | Valve body female threads for needle | FIG. 6, 10, and 14 |
| 28 | Upper release tube body | FIG. 9 |
| 29 | Upper release tube passage | FIG. 9 |
| 30 | Release tube seat | FIG. 9 |
| 31 | Lower release tube | FIG. 9 |
| 32 | Lower release passage | FIG. 9 |
| 33 | Open end of release tube | FIG. 9 |
| 34 | Valve stem assembly with passages | FIG. 9 and 11 |
| 35 | Aerosol can valve body | FIG. 11 and 14 |
| 36 | Aerosol cap valve spring | FIG. 11 and 14 |
| 37 | Gas or fluid path through system | FIG. 11 |
| 38 | Typical valve body passage port | FIG. 6 |
| 39 | Upper valve body seal pocket | FIG. 6 |
| 40 | Needle assembly body | FIG. 5 |
| 41 | Aerosol can cap seal surface | FIG. 8 and 11 |
| 42 | Alternate Stem | FIG. 12, 13, and 14 |
| 43 | Alternate stem threads | FIG. 12, 13, and 14 |
| 44 | Alternate valve stem depressing ball | FIG. 12, 13, and 14 |
| 45 | Alternate stem pushing pen | FIG. 12 and 13 |
| 46 | Hourglass shaped relief area on | FIG. 12 and 13 |
| | alternate stem pushing pen | |
| 47 | Alternate valve stem attachment knurl | FIG. 12 and 14 |
| 48 | Stem shaft | FIG. 13 |
| 49 | Valve stem seat | FIG. 12 and 13 |
| 50 | Narrowed valve stem | FIG. 12 and 13 |
| 51 | Flow path of liquid and or gas | FIG. 14 |

### DETAILED DESCRIPTION

Attention should be had to FIG. 1 number 1 “Can and valve assembly” were depicted is number 3 a common style R-134a can and 2 “Valve Complete”. The number 2 valve is of common art and uses the puncher pen method of breaching the number 4 can cap to open the container.

To better understand this type of prior art attention should be given to FIG. 3 where number 4 Can cap is better defined as having number 8 solid cap puncher point and number 7 male ½ inch Acme threads on the body.

To further describe the number 1 of FIG. 1 can cap and valve assembly attention should be given to FIG. 2 were the number 2 Valve complete (prior art) is better described as having number 5 Valve Body and number 6 Piercing needle assembly. To further describe this said assembly a section view A-A of number 2 valve complete is provided in FIG. 6.

As depicted in FIG. 6 said valve assembly is compiled of number 5 valve body also shown in FIGS. 2 and 4 and number 6, Piercing needle assembly of FIGS. 2, 5, and 6.
The number 5 Valve body has a female threaded portion number (24) ½ inch female Acme thread and a (13) Seal shown in FIG. 6. The 24 said threads are the attachment mechanism to affix the number 2 Valve complete to the number 7 Male ½ Acme thread of cap in FIG. 3.

The valve body (5) of FIG. 6 also employs (27) Valve body female threads which allow the number 20 needle assembly threads of FIG. 5 to ride up and down the length of the 27 valve body threads as No. 6 piercing needle assembly is rotated.

During the typical application of the valve 2, said valve assembly is screwed onto the 4 can cap via the 24 female ½ Acme threads over the 7 male ½ Acme can cap threads until the 13 seal of FIG. 6 becomes tightly sealed against the upper area of 8 Solid cap puncher point of FIG. 3 creating a seal between the 3 can with 4 can cap and the 2 valve complete.

After the 2 valve assembly is in place on the can assembly, the 14 Tee knob is rotated clockwise which rotates the 20 needle assembly threads FIG. 5 forcing the 22 Piercing needle into and through the 8 Solid cap puncher point breaching the container. Continuing to rotate the 14 tee knob clockwise will place the valve in an interference fit between 21 Needle seat of FIGS. 5 & 6 and the 23 valve body seat of FIG. 6. This should provide a can to valve seal.

Rotating the 14 Tee knob counterclockwise pulls the 22 piercing needle of FIG. 5 up and out of 4 can cap releasing the liquid and or gases content of the can. This said can content passes thru a hole (not depicted) in the center of seal 13 of FIG. 6. The gas or liquid then pass thru 38 valve body passage port which is slightly larger than 22 piercing needle up and thru a void created below the 20 needle assembly threads as it is rotated to its counterclockwise position. The gas or liquid then exits the valve thru 26 exiting tube of FIGS. 4 and 6.

In a typical application a hose or fitting would be affixed the exiting tube via 25 mail threads of FIG. 4. This affixed hose or fitting (not shown) would then attach to the automobiles low pressure side of the AC system to allow the charging of the system.

During the release of gas or liquid from the said can and valve assembly pressure is created within the valve system. To prevent the unwanted escape of gas or liquid from the upper side of the 2 valve complete a common art seal system is employed.

The said seal system is best depicted in FIG. 5 and is compiled of 19 Lower metal seal washer, 18 Upper rubber seal washer, 17 Upper metal seal washer and 15 retaining nut.

The employment of this system is best depicted in FIG. 6 at location 39 the upper valve body seal pocket. It should be noted that as the said 6 piercing needle assembly is threaded into the said 5 valve body the said seal system is drawn into a position where 15 retaining nut of FIG. 5 and the 16 retaining threads for the needle assembly of FIG. 4 can be threaded together in a clockwise direction as to draw the said seal system into place within the 39 upper valve body seal pocket. Said seal system is dimensionally constructed as to cause a interference fit between the 18 upper rubber seal washer, the 40 needle assembly body of FIGS. 5 and 39 upper valve and body seal pocket of FIG. 6.

Said interference fit can be increased as the 15 retaining nut is tightened to the 5 valve body via 16 retaining threads for the needle assembly. This said interference fit seals the said gas or liquid from escaping the valve.

It should be noted that using this type of piercing valve system offers no means for sealing a can cap after it has been punctured and offers no positive way of sealing the remaining contents of the can after servicing the automobiles air condensing system.

Using this type of common art valve system on an arosal type can valve can cause irreversible damage to the can valve allowing uncontrolled escape of the content.
In addition when the valve is rotated clockwise until it stops rotating the valve becomes misleadingly sealed. In this condition a unseasoned technician could mistakenly believe the can is empty and unscrew the complete valve from the can allowing freezing gas and liquid to escape possibly causing personal injury.

The improved valves employ many of the same components as the common art valve although the first improved valve employs tubs with passages to transport the can content from a sealable valve can cap. The second provides a hourglass shaped stem to release the gas or liquid from the re-sealable valve can cap. In addition these valves can not mislead the user. The can cap valve is opened when the knob is rotated clockwise and closed when rotated counterclockwise.

To best describe the improved valves attention should be given to FIG. 7 where a number 12 chemical can is shown with a number 9 can cap aerosol valve style. This particular valve is produced by Newman-Green and is referred to as K-12-118 Acme thread self sealing aerosol valve.

This aerosol valve cap design 9 of FIG. 7 is better described by giving reference to FIG. 8 where number 7 is the male ½ Acme thread and 11 is the can cap valve with 10 aerosol cap valve seal. In use the said 7 threads screw into the 24 ½ Acme threads of the 5 valve body of FIG. 11 retaining the valve assembly onto the can cap and chemical can assembly.

To best describe the function of the first improved valve assembly, attention should be given to FIG. 10 where the identical prior art valve body 5 of FIGS. 2, 4, and 6 is employed. As with the prior art valve body employed is 27 valve body female threads of FIGS. 10 and 6. Threaded into 27 is the 20 needle assembly threads of FIG. 9 which is part of the 34 valve assembly with passages.

As the tee knob 14 of FIG. 9 is rotated clockwise the assembly screws into the valve body. Rotating the knob clockwise until it stops turning allows 31 the lower release tube of FIG. 9 to pass thru the 13 seal of FIG. 10 and into a position were it has opened the valve 11 of can cap 9 of FIG. 11.

When the valve has stopped rotating a shoulder 30 release tube seat of FIG. 9 has made contact with 23 valve body seat of FIG. 10 preventing over travel of the 31 lower release tube of FIG. 9. This said seat contact along with the precise length of 31 lower release tube prevent damage to 9 can cap aerosol valve by preventing over compression of the 11 can cap valve of 9 of FIG. 11.

To further understand the geometry and function of the said improved valve assembly attention should be given to FIG. 11, a cutaway view of the improved valve assembly in open operating position on the 9 can cap aerosol can cap valve.

It should be understood that when the said male threads 7 of cap 9 are screwed into the 24 threads of the 5 valve body a seal is formed between 41 aerosol can cap seal face of FIGS. 8 and 11 and 13 seal. After the threads have been adequately tightened to form said seal, the 34 valve assembly of FIG. 11 can be rotated clockwise by said 14 tee knob. This threading action slowly moves 11 the can cap valve of FIG. 11 downward compressing 36 aerosol cap valve spring located below 11. As said 11 is moved downward the gas and or liquid begins to be slowly released from the said can assembly. When the rotation stops, the valve is in the most open position.

In this open position the release path of the gas or liquid is different than from prior art as viewed in FIG. 11. A view No. 37 of FIG. 11 is the gas or fluid flow path through the system. This view is a line gray in color with arrows. Attention should be given to FIG. 11 where the flow path begins at 35 aerosol can valve body which is a plastic component that is retained into the metal of the can cap. This said 35 valve body is tubular in shape and open on the lower end and employs voids around its sides. The center is configured to shoulder the 36 valve spring which applies upward pressure on the 11 cap valve. Within the shoulder area of 35 is a center hole or passage which allows gas or liquid to pass thru the said hole and into and thru the spring area. The 11 valve is configured as to let gas or liquid pass thru the center and or around the outside of its body thru vertical slots, voids, or passages.

With said valve 11 in an open position the gas or liquid flows around said valve and into an open area created when the said valve is pushed downward from 10 aerosol can valve seal, this area is slightly above the top of the said valve.

In the center of this area is 31 the lower release tube and 32 the lower release tube passage of FIG. 9.
This area is sealed from gas or fluid escape by two seals. The first is 10 aerosols can cap valve seal of FIG. 11. This seal is part of the 9 can cap and is located between the 35 valve body and the 41 cap seal surface. This seal is washer shaped and is dimensionally produced as to have a sealing interference fit with the 31 lower release tube on the inside diameter of the seal. This seal 10 is also provides the sealing surface for the 11 can cap valve. The second mentioned seal is the said seal 13 within the valve body itself that is sealed as the said valve assembly is screwed to the said can assembly.

As the gas or liquid flows into this area it enters the 31 lower release tube thru 32 lower release passage of FIG. 9. The gas then travels thru the 31 tub and exits the 29 upper release tube of FIG. 9.

The area that the gas or liquid is released into is simply clearance between the 28 upper release tube body of FIGS. 9 and 27 valve body female.
As the gas and or liquid passes thru this area it then exits the 5 valve body thru 26 the exiting tube 26 of FIGS. 4 and 10.

Pryor to the valve use the user will have placed a hose or fitting onto 25 male thread of the exiting tube 26 of FIG. 10 that allows attachment of the system to the automobile air conditioning system before opening the said valve and allowing the gas to escape.

To stop the flow of gas or liquid and keep the remaining content of the can in the can, the operator simply rotates the said 14 tee knob in a counterclockwise direction. This retracts the 34 valve assembly with passages from the can cap allowing 36 the valve spring to urge the 11 can cap valve upward into a sealed position with 10 aerosol can cap seal. This effectively stops the flow of gas or liquid.

The user can then unscrew the entire valve assemble of FIG. 10 from the 9 can cap without fear of escaping gas or liquid.

As an alternative to the same issue a second valve stem design is introduced which allows a greater volume of gas or liquid to pass through the valve assembly. The alternative valve stem assembly can best be described by looking at FIG. 8 number 9 can valve. Number 9 can valve is attached to number 12 of FIG. 7 number 12 can, by using male and female threads best described by looking at FIG. 14. The referred to male threads 7 of the can cap 9 of FIG. 8 are also found on FIG. 14 number 7. The referred female threads are shown in section views FIGS. 6 and 10 as number 24. Screwing valve body number 5 of FIGS. 2,4,6, and 14 onto can cap of FIGS. 8 and 14, number 9 attaches the valve to the can and Newman-Green cap valve assembly, number 1 of FIG. 1.

To further describe the function of the alternate stem, number 42, best shown in FIGS. 12,13, and 14, attention should be given to FIG. 14. It should be understood that number 42 threads into number 5 valve body, best shown in FIG. 14. To further understand, it should be noted that number 14, valve actuation handle of FIGS. 5, 9, and 14, is rotated within the threads urging downward the number 44 alternate valve stem depressing ball of FIGS. 12, 13, and 14, against number 11 Newman-Green can valve. As the stem is further rotated, it urges number 11 Newman-Green can valve downward, thereby opening the Newman-Green valve cap best shown on FIG. 14. It should be noted that this style of Newman-Green valve is used in the aerosol can industry for products such as spray paint.

With the Newman-Green can cap valve number 11 open, it allows a flow of gas past the alternate valve stem depressing ball number 44, upwards and alongside alternate stem pushing pin number 45, of FIGS. 12 and 13. The gas travels up alternate stem number 42, past valve body seat number 23 of FIGS. 6 and 10 and around narrow stem shaft number 50, of FIG. 13, thereby allowing the gas or liquid to exit number 26, of FIG. 14. It should be noted that the stem shaft number 50 of FIGS. 12 and 13 is of smaller diameter than the thread root diameter of number 27 of FIGS. 6, 10, and 14 thereby allowing the gas to pass between the two parts.

To further describe the alternate stem number 42 of FIGS. 12, 13, and 14, it should be understood that the valve stem seat number 49 of FIGS. 12 and 13 comes in contact with the valve body seat number 23, FIGS. 6 and 10, when the valve is rotated to open the Newman-Green valve number 11 of FIGS. 8, 11, and 14 completely.

It should be understood that in a typical valve application when two valve seats come together, within the stem and the body assembly, flow of the fluid or gas is stopped. To allow the gas to pass this area and also allow the stem to have a seated stop, a narrowed area or flats on alternate stem number 42, in area shown as number 46 of FIGS. 12 and 13 is needed. This area of flats extends upward and downward from the valve stem seat number 49 of FIGS. 12 and 13, enough in both directions to allow passage of the gas or liquid through the valve body seat number 23 of FIGS. 12 and 13. This allows an unrestricted flow of the gas or liquid through the valve. In addition to allowing the flow past seat 23 of FIGS. 6 and 10, Extending these flats downward to or near the 44 depressing ball of FIGS. 12 and 13 increases the flow of gas or liquid threw the 4 Newman-Green can cap of FIGS. 1 and 3.

From the above explanation it becomes apparent the benefits of the new improved resealing valve systems over the common art can puncture system.

The safety aspect is reviled because the new valve only allows the aerosol can cap to be open or closed where as the common art valve effectively has two closed positions if used on the aerosol style can cap. This second closed position can lead to confusion and early removal of the puncture valve from the can allowing it to vent into the atmosphere and possibly causing injury to the user.
Suitable Materials for Producing this Product:

It should be noted that the 34 valve assembly can be made from suitable metal materials such as 1018 or 1215 steel or say 304 stainless steel. Typically this type of part would be made on CNC leaths or screw machines. The tee handle could be die cast metal or injection molded plastic. The 15 retaining nut generally would be a machined part made from aluminum, steel, and brass, plastic or similar suitable materials.

The valve body 5 would typically be made from steel, aluminum, brass or plastic with suitable metal inserts. The parts would be ran from bar stock or in some cases it could be die cast with secondary machine operations.
The rubber like materials for the seals would be made from compatible material with the content of the can. The seal backup washers can be made of steel, aluminum, brass or similar materials and would preferable be stamped.
The components of the valve can be produced with the following manufacturing processes. The valve body number 5, typically made of aluminum or brass, from a machining or die-cast operation. The stem assembly is typically machined from bar stock as a screw machine or CNC machine part, not to say it could not be powder metal or die-cast. The valve actuation handle number 14 of FIGS. 5, 9, and 14 could be die-cast, powder metal, or plastic injection molding.

### BRIEF SUMMARY OF THE INVENTION

Within the packaging and application field of automotive air conditioner Freon a problem of resealing the Freon dispensing cans has existed. With the introduction of threaded resalable aerosol can cap the problem could be corrected by resealing the cans after each application. The can caps are found on the upper most part of the cans.
The introduction of the new can caps lead to the need of a new style stem within the existing can taps to properly open and dispense the gas or liquid.
This stem must properly engage and depress valve components within the can cap without damaging the can cap.
Disclosed are stems that properly extend into the can cap from the tap assembly and open and close the can cap valve.

What I claim is:

1. A valve stem for use in aerosol can caps; stem being round and approximately two inches in length with at least four distinctive profiles along a shaft with one end tubular in shape with a outer diameter of a size as to extend into the can cap opening with enough length to extending from a valve body to compress and open said can cap valve with first tube area followed by a slightly larger diameter tubular area extending upward the stem shaft forming a external seat at the transition of the two tubular diameters; positioned along and above the second diameter are threads with a root diameter larger than the second tubular diameter the threads extend approximately one eighth of the stems length with a fourth portion of the stem slightly smaller in diameter than the root diameter of the threads extending from the threaded area to form a shaft with means of affixing a member for rotating the stem shaft; said first and second tubular portions of the stem having two or more cross holes with the first said cross hole being located near the further most portion of the small diameter tube followed by the second hole located along the length of the second larger diameter tubular area.

2. A valve stem of claim one where the first small diameter tube and the second larger diameter tube are from two pieces pressed or affixed together; said small diameter tube having one end closed at the furthest most end; said closed end positioned at the furthest most end of the valve stem.

3. A valve stem for use in aerosol can caps; stem being round and approximately one fourth of and inch in diameter and approximately two inches in length with at least five distinctive profiles along a shaft with the first end being a larger diameter of an hour glass shape and of a diameter as to fit snugly into the can cap valve with a length of approximately one hundred thousands long; the first short portion of the profile is followed by a substantially smaller diameter portion of the stem long enough to extend beyond the can cap and into the valve body followed by a third larger and longer area extending along the shaft forming the said hourglass shape; the transition point between the said second and third profile forming a seat; located on the side of the second and third profiles are one or more flats that extend from the surface of the second profile onto the third profile; above the said seat of the third profile are threads positioned somewhat centrally located along the stem with a root diameter larger than said third profile; said threads extend approximately one eight the length of the stem and are followed by an upper diameter smaller than the thread root diameter extending from the threaded area to form a shaft with means of affixing a member for rotating the shaft stem.
